(19) United States
(12) Patent Application Publication
(10) Pub. No.: US 2015/0239283 A1
(43) Pub. Date: Aug. 27, 2015

(54) METHODS OF MAKING AN ARTWORK AND ARTWORKS SO FORMED

(71) Applicants: Howard S. Clark, Salt Lake City, UT (US); Jeffrey Karl Cobabe, Salt Lake City, UT (US)

(72) Inventors: Howard S. Clark, Salt Lake City, UT (US); Jeffrey Karl Cobabe, Salt Lake City, UT (US)

(21) Appl. No.: 14/189,612

(22) Filed: Feb. 25, 2014

(51) Int. Cl. B44D 5/10; B44F 11/00

(52) U.S. Cl. CPC B44D 5/10; B44F 11/00

(57) ABSTRACT

In embodiments, an artwork and a method for creating an artwork are disclosed. A method comprises texturing a surface by applying a substantially silicone-free caulk to a substrate, applying one or more water-soluble aniline-containing dyes to the textured surface to produce a desired appearance, and applying a polyurethane-containing protective coating over the substrate, substantially silicone-free caulk, and one or more water-soluble aniline-containing dyes collectively. The artwork may include a textured surface formed upon a substrate using a substantially silicone-free caulk, one or more water-soluble aniline-containing dyes applied to the textured surface, and an oil-based polyurethane-containing protective coating over the textured surface and water-soluble aniline containing dyes.

### BACKGROUND

Works of visual art have been made for many centuries. Works of visual art may encompass many forms including, for example, paintings, drawings, sculptures, photography, and performing arts. A work of art may be a simple geometric sculpture, a black and white line drawing, an intricately painted mural, or a colorful abstract painting.

Many enjoy artistic expression as a hobby or a profession. However, it may take years or decades to become proficient at or develop a characteristic style of artistic impression. For example, it may take a painter many years to learn to effectively paint a portrait depicting a person. Alternatively, it may take an abstract artist many years to develop a characteristic style of brush strokes or color schemes before such an artist becomes known for or can reproduce such a style.

There are many mediums in which such visual artistic works may be expressed. Typically, a painting may be composed on a canvas, paper, wood, architecture, or metal. Additionally, a painting may incorporate one of many types of paints or coloring agents, for example, oil color paints, water color paint, acrylic paint, and latex paint. Different forms of coloring may also be incorporated into artworks, including enamels, inks, and dyes. Further, use and manipulations of thicker paints, i.e. oil paints, can leave characteristic patterns or brush stroke impressions on a finished artwork, many of which may be characteristic of specific styles or artists.

While many enjoy painting as a hobby, many do not have the time or money to invest in the purchase of artistic supplies and practice. Many would enjoy producing a piece of visual art having details indicative of one having many years of practice or great talent without investing the time or large amounts of money developing the skills traditionally necessary to do so.

### SUMMARY

Embodiments of the invention relate to methods for creating works of art that include combinations of dyes, caulking, and protective coatings. In embodiments, artwork may include a surface having texture formed thereon by applying and manipulating a coating of caulk on the surface. For specific color, dye may be applied to the textured surface. A protectant applied over the dye and the caulking provides protection for the artwork and may enhance color.

In an embodiment, a method of making an artwork is disclosed. The method includes texturing a surface of a canvas by applying a substantially silicone-free caulk to the canvas. The method includes tailoring the texture of the applied substantially silicone-free caulk to create a textured surface. The method additionally includes applying one or more water-soluble aniline-containing dyes to the textured surface. The method further includes coating the textured surface including the one or more water-soluble aniline-containing dyes with a polyurethane-containing protectant.

In an embodiment, an artwork includes a substrate and a substantially silicone-free caulk covering at least a portion of the substrate to define a textured surface. The artwork further includes at least a single water-soluble aniline-containing dye applied to the textured surface, and an oil-based polyurethane-containing protectant coating the textured surface and the water-soluble aniline-containing dye.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1A is a plan view of an artistic work created according to an embodiment.

FIG. 1B is an isometric view of the artistic work shown in FIG. 1A.

FIG. 2 is a flow diagram illustrating a method for making an artwork according to an embodiment.

FIG. 3 is a flow diagram illustrating a method for texturing a surface according to an embodiment.

FIG. 4A is an isometric view of a method of applying a caulk to a surface according to an embodiment.

FIG. 4B is an isometric view of a method of applying a caulk to a surface according to an embodiment.

FIG. 4C is an isometric view of a method of applying a caulk to a surface according to an embodiment.

FIG. 5A is a front view of a textured surface according to an embodiment.

FIG. 5B is a side cross-sectional view of the textured surface of the artwork shown in FIG. 5A.

FIG. 6A is an isometric view of a method of applying a dye to a textured surface according to an embodiment.

FIG. 6B is an isometric view of a method of applying a dye to a textured surface according to an embodiment.

FIG. 6C is an isometric view of a method of applying a dye to a textured surface according to an embodiment.

FIG. 7A is an isometric view of a method of applying a protective coating to a textured surface according to an embodiment.

FIG. 7B is an isometric view of a method of applying a protective coating to a textured surface according to an embodiment.

### DETAILED DESCRIPTION

Embodiments of the invention relate to methods for creating works of art that include inventive combinations of dyes, caulking, and protective coatings. The inventive combinations of dyes, caulking and protective coatings disclosed include combinations providing vibrancy and appearance not believed to be achievable without the unique combination of materials and methods described herein. Caulking is typically used to fill or seal woodworks or as a construction material. Dyes, specifically aniline-containing dyes, are typically used to stain wood or textiles. Polyurethane-containing protectants are typically used to protect wood, such as flooring or furniture. However, as described in more detail below, a silicone-free caulk (e.g., a painter's caulk) may provide texture and porosity to a surface for adsorbing and/or absorbing dyes. Further, an aniline-containing dye such as a water-soluble aniline-containing dye or alcohol-soluble aniline-containing dye may adsorb, absorb, saturate, or combinations thereof into a substantially silicone-free caulk, thereby providing color to the textured surface not achievable without using such a combination of materials. Applying a polyurethane-containing protectant over the textured surface and the water-soluble (or alcohol-soluble) aniline-containing dyes provides a protective coating which further adds definition and vibrancy to the colors of the water-soluble (or alcohol-soluble) aniline-containing dyes not present before application of the polyurethane-containing protectant.

While water-soluble aniline-containing dyes are used herein as examples, the same acts described herein using water-soluble aniline-containing dyes may be carried out using alcohol-soluble aniline containing dyes. In an embodiment, the water-soluble aniline-containing dye may also be alcohol-soluble. In an embodiment, an alcohol-soluble aniline-containing dye may not be soluble in water. In embodiments, both water-soluble and alcohol-soluble aniline-containing dyes (i.e., at least one water-soluble and at least one alcohol-soluble aniline-containing dye) may be used in combination according to any of the acts described herein.

In an embodiment, an artwork may include a surface having texture formed thereon by applying and manipulating a coating of caulk on the surface. For specific color, one or more dyes may be applied to the textured surface. A protective coating applied over the dye and the caulking provides protection for the artwork. As used herein, “caulking” and “caulk” are intended to have the same meaning

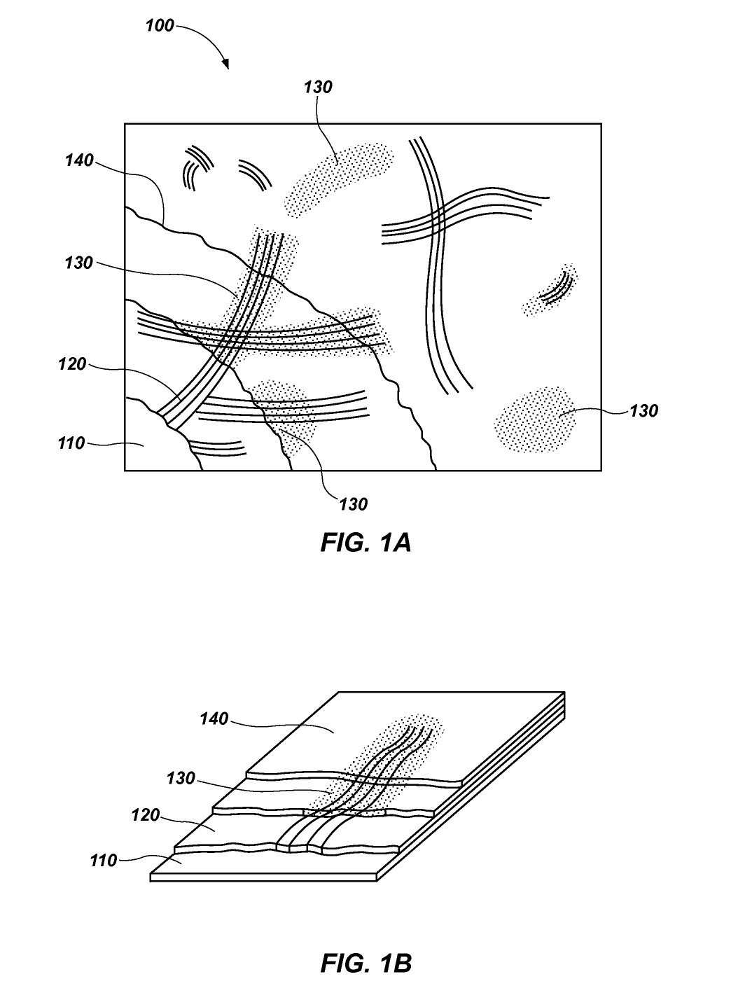

FIGS. 1A and 1B illustrate an embodiment of an artwork 100 created by any of the methods disclosed herein. Artwork 100 may include a surface 110 having texture formed by applying a coating of caulk 120 to the surface 110. For specific color, at least a single dye 130 may be applied to the textured surface. A protectant 140 applied over the dye 130 and the caulking 120 provides protection and contrast for the dyes 130 thereby making the colors more vibrant. In an embodiment, artwork 100 may include a non-silicone or substantially silicone-free painter's caulk applied over a canvas, aniline-containing dye applied over the caulking, and a polyurethane-containing protectant applied over the caulking and dye. This combination of materials and application creates vibrancy in the color of the dyes not otherwise believed to be present using different materials or methods.

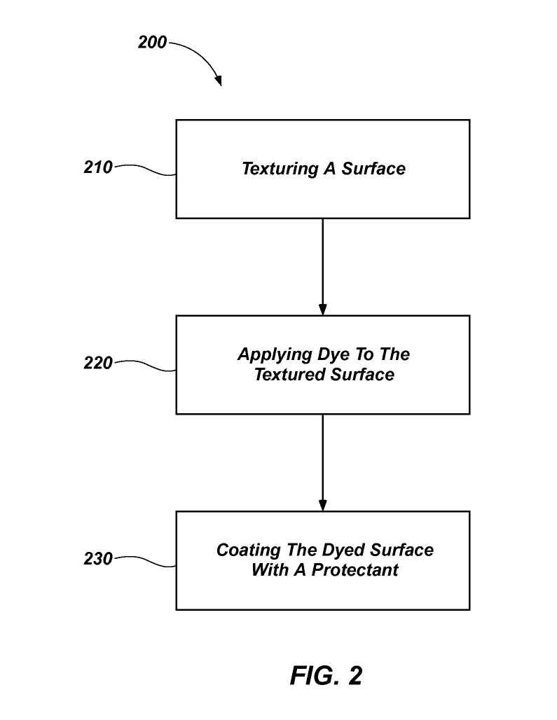

FIG. 2 is a schematic illustration depicting an embodiment of a method of making a work of art. The method 200 includes a first act 210 of texturing a surface, a second act 220 of applying one or more dyes to the textured surface, and an act 230 of coating the dyed surface with a protectant. More details, including embodiments of each act 210, 220, and 230 are provided herein.

In an embodiment, a substrate or surface may include, by way of non-limiting example, walls; wood; canvas; materials having texture sufficient to hold caulking, dye, or paint; or combinations thereof. In an embodiment, a substrate or surface includes canvas stretched over a wooden frame or stretcher, or a canvas panel (i.e., canvas adhered to a backing such as a board). The canvas may be any form of canvas, by way of non-limiting example, a gesso canvas, a linen canvas, or a cotton duck canvas. The surface may provide a desired amount of texture to receive application of caulk and/or dye in the method 200. The desired amount of texture of a surface may be formulated upon the ability of the surface to hold, retain, or bond with a material applied to the surface. The desired amount of texture may be formulated upon the desired visual effect exhibited in the finished product after application of materials to the surface, including caulking, dye, and a varnish in an embodiment. By way of example, a desired amount of texture of a surface may include a coarse woven canvas texture sufficient for the weave of the canvas to be visible in the finished artwork 100 after application of caulking, dyes, varnish, or combinations thereof. In another embodiment, a desired amount of texture of a surface may include a smooth texture wherein the weave of a canvas is sufficiently fine or tight such that after application of caulking, dyes, varnish, or combinations thereof, the weave of the canvas is no longer visible. In an embodiment, a canvas panel may comprise canvas, substantially as any described herein, and a plywood backing, a particle board backing, a medium-density fiberboard backing, a high-density fiberboard backing, a foam board backing, a cardboard backing, or any other backing sufficient to provide a rigid flat surface for canvas to adhere to.

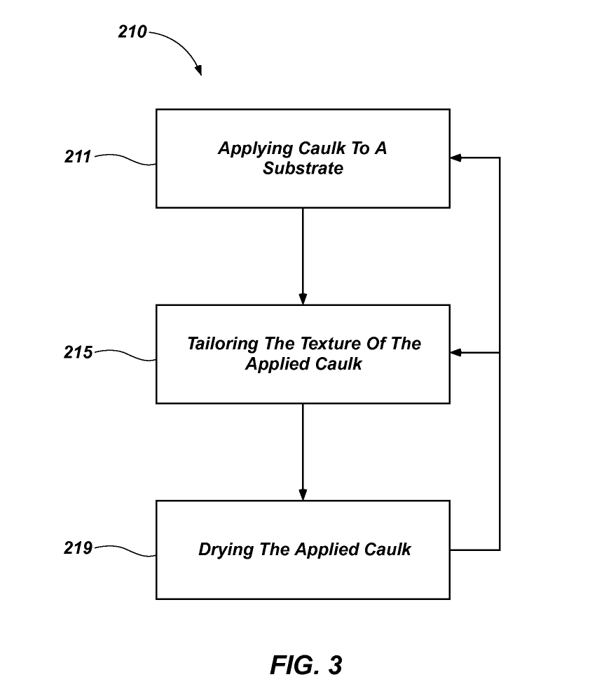

FIG. 3 is a schematic illustration depicting a method of texturing a surface 210. The act of texturing a surface 210 may include applying caulk 211 to a canvas, tailoring the texture of the caulk 215 on the canvas, and drying the caulk 219 on the canvas. In an embodiment, the caulk may be any type of caulk that is substantially free of silicone. In embodiments, an acrylic latex painter's caulk or vinyl latex caulk may be used. Examples of desirable caulking may include, but not be limited to, DAP® ALEX® silicone-free acrylic latex caulk, WHITE LIGHTNING™ Painter's Preferred Acrylic Latex Caulk, or any other commercially available silicone-free acrylic latex caulk. A particular caulk may be selected based on any number of factors, including, but not limited to, drying time, color, porosity, ability to hold dyes, ability to bond to a surface, malleability, ability to be spread on a canvas, or combinations thereof.

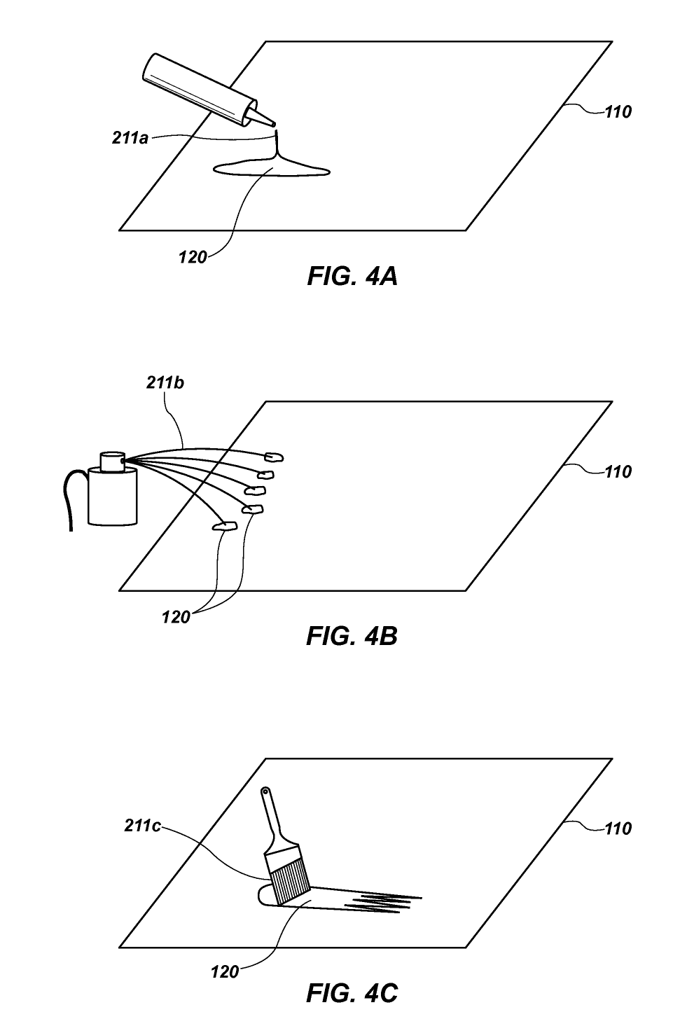

In an embodiment of the act 210 of texturing a surface 110, a user may, in act 211, apply a caulk 120 to a surface 110, wherein the caulk 120 may be substantially silicone-free acrylic latex caulk. In embodiments depicted in FIGS. 4A-4C, applying the substantially silicone-free acrylic latex caulk 420 to the surface 410 may include the act 211a of directing the caulk out of a tube onto the surface 110. Other non-limiting examples of the act 211 of applying the substantially silicone-free acrylic latex caulk 420 to a surface 410 also includes, placing the caulk 420 on the surface with a spatula, trowel or other tool; throwing or spattering (i.e. to produce a splattered effect); thinning the silicone-free acrylic latex caulk with a solvent (e.g., water) and brushing 211c the caulk 420 onto the surface 410 with a brush 404, spraying 211b the caulk 420 onto the surface 410, or rolling the caulk 420 onto the surface 410; and/or combinations thereof.

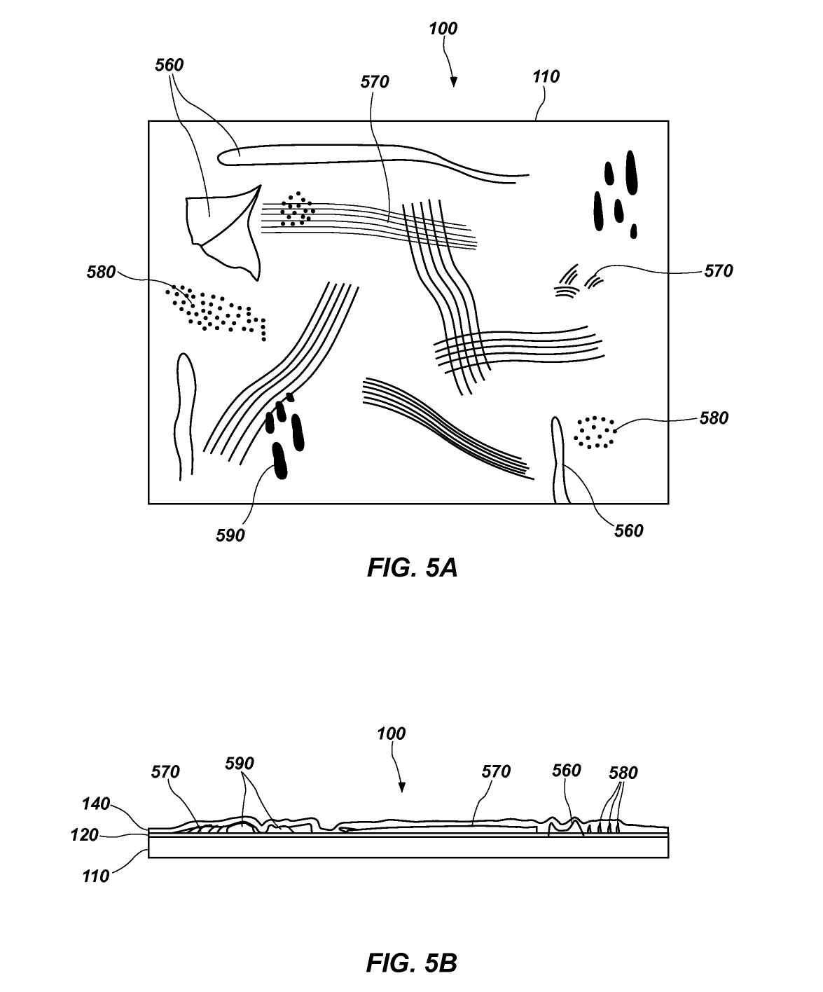

It will be readily understood that for ease of use, reference numbers of similar parts or process acts will be correlated to similar references numbers in a different numbered series (i.e. caulking 120 in FIG. 1 is similar to caulking 520 in FIG. 5). Accordingly, combinations of the subject matter recited in relation to a numbered series may also relate to a different numbered series, notably where reference numbers correlate to each other. Additionally, some reference numbers will be maintained throughout, with a letter designation added to the number to differentiate between illustrated embodiments (i.e. 211a on FIG. 4A and 211b on FIG. 4B).

In an embodiment, the act 211 of applying the caulk may at least partially penetrate or infiltrate caulk into the fibers or structure of the surface 110. For example, on a canvas, the silicon-free acrylic latex caulk 120 may at least absorb or partially soak into the fibers of the canvas, the caulk 120 may infiltrate into the spaces between the fibers of the canvas, thereby causing bonding between the caulk 120 and the surface 110 comprising canvas, and/or the caulk may adsorb or adhere to the surface of the canvas like an adhesive.

The act 211 of applying the caulk may also include applying a certain thickness of caulk 120 to a surface or substrate 110. Thickness of the applied caulk can depend on the desired aesthetic properties of the artwork and/or the desired malleability or drying time of the caulk 120. The applied caulk 120 may exhibit a thickness of about 0.062 inches, about 0.125 inches, about 0.250 inches, about 0.5 inches, or about 1.0 inches. Additionally, the applied caulk may exhibit a range of thicknesses from about 0.005 inches to about 3.0 inches. For example, the caulking may be about 0.010 inches to about 2.5 inches, about 0.062 inches to about 2 inches, or about 0.125 inches to about 1.0 inches. It will be readily understood that the caulk with vary in thickness based on any textured details, features, and/or structures.

Following application of caulk 120 to a surface 110, in another act 215 a user may tailor the caulk to provide a desired texture. Desired textures may include, but are not limited to, porous textures; three-dimensional features further including scrapes, bumps, brushstroke impressions, splatters, sputtering, blotting impressions, smear impressions, or combinations thereof; canvas weave textures, substantially smooth textures (i.e. devoid of any canvas or other underlying substrate impression), or combinations thereof. A more porous textured surface will hold more dye in the pores of the caulking, and a surface having larger three-dimensional features will hold more dye in the three-dimensional features due to increased pooling in the three-dimensional features. By using both porous and three-dimensional textures a user may obtain greater dye saturation on the peaks and surfaces of three-dimensional features that dyes would normally run off of if the medium were not porous.

The act 215 of tailoring the texture of the applied caulk may be carried out before and/or after the applied caulk has dried. In an embodiment, the act 215 of tailoring the texture of the applied caulk may include spreading or smearing undried applied caulk with a spatula, trowel, knife, or other tool along a portion of the surface. Smearing the undried applied caulk may create differences in the depth or thickness of the caulk at different points on the surface. An embodiment of a spatula may include a painter's spatula, which may further include one of many embodiments of blades in differing shapes and sizes. It is to be understood that “smear” as used herein may alternatively be called or include the act of and those marks left on a substance by spreading, stroking, dragging, depositing or otherwise manipulating a substance on a substrate. A smear may be exhibited by an indentation, smoothing, or roughening of the caulk across substantially all of the length or height of the surface, only a small portion of the surface, or many points along the length or height of the surface. A smear or smears may be continuous or a broken set of smaller smears. Such smearing may have the effect of smoothing out portions of the caulk 120 on the surface 110; smearing may also have the effect of providing indentations where downward pressure is applied to the caulk 120. In an embodiment, the caulk 120 may be textured by blotting the caulk using a sponge. In another embodiment, smearing the caulk 120 may be done without the use of a tool, such as with a finger or hand. In an embodiment, tailoring the texture of caulking may include scraping the surface of the substrate, thereby leaving indentations in the caulk. In another embodiment, tailoring the texture of the applied caulk may include a combination of a scraping motion and a smearing motion such that indentations or signs of both are exhibited in the undried applied caulk.

In another embodiment, the act 215 of tailoring the texture of the applied caulk may include brushing the undried applied caulk with a brush (i.e. a paint brush) to provide a brushed texture. A brushed texture may be accomplished by making brush impressions in the applied caulking including but not limited to long brush strokes, short brush strokes, dabbing brush strokes, blotting brush impressions, stabbing or patting brush impressions, or any other type of brush stroke, impression and/or combinations thereof to achieve the desired texture of an at least partially painted or brushed surface. Embodiments may employ different sized brushes, different types of brushes, and brushes having different bristle thicknesses. Brush types include but are not limited to paint brushes, sponges or sponge brushes, cleaning brushes, hair brushes and wire brushes. Embodiments may include combinations of single or multiple brush stroke types and single or multiple brush types and/or sizes to achieve the desire texture.

In another embodiment, the act 215 of tailoring the texture of the applied caulk 120 may include tilting the surface to allow the undried applied caulk to run down the surface in the direction the canvas is tilted in to provide a desired texture (i.e. a running paint look). Tailoring the texture or appearance may be aided by using a thinned caulk 120 on the surface 110. It will be readily understood that thinning the caulk 120 with a solvent or water will decrease the viscosity of the caulk 120 and will also increase the drying time of the caulk 120. A user may desire to thin the caulk 120 to decrease the viscosity and/or increase the workability of the caulk 120 and/or a user may wish to thin the caulk 120 to allow more time to work with the caulk 120 before it dries. A runny appearance may be obtained by thinning the caulk 120 with a solvent or water and placing the caulk on the surface followed by tilting the canvas to allow the caulk 120 to run in a desired direction or directions.

In another embodiment, a user may create a textured feature having a structure defining a shape on the surface 110 using the caulk 120. In an embodiment of a textured feature having structure, a user may create a three-dimensional profile of a facial feature such as a nose by manipulating the caulk 120 to create the appearance of a nose. Embodiments of textured features having structure include geographic, architectural, anatomical, mechanical, landscape, combinations thereof, or any other features so desired. An embodiment may include forming a profile of a mountain in order to provide contrast for the mountain before painting or dying the caulk 120.

FIGS. 5A and 5B depict illustrative embodiments of the tailored textures in caulking on the surface discussed above. In FIG. 5A, smears 560 made with a spatula are depicted in embodiments. Brush strokes 570 are depicted in embodiments. Brush dab marks 580 are depicted in embodiments. Smears 590 made by human fingers are depicted in embodiments. In FIG. 5B the same features described in FIG. 5A are shown in profile to illustrate that the corresponding smears and brush strokes can provide some three-dimensional texture to the applied caulk 520 on the surface 510. FIG. 5B also illustrates the relationship between the surface 510 and the caulking 520 of the tailored texture on artwork 500. It is to be understood that the illustrative embodiments of the textures described are not intended to be limiting, rather merely examples of some of the textures and methods of achieving those textures contemplated. Differing versions of textures or methods of achieving those textures are contemplated using different tools, using different lengths and angles of tool and methods of creating texture (i.e. brush strokes), and combinations thereof to tailor the texture of the caulk to the desired texture.

In an embodiment, the method 210 of texturing a surface may also include the act 219 of drying applied caulking and its tailored texture. Drying the applied and textured caulk 120 may be accomplished by leaving the surface having the applied and textured caulk in an ambient environment for an amount of time sufficient to accomplish drying. In another embodiment, drying the applied textured caulk may include heating the surface having the applied texture caulk or forcing air over the surface having the applied texture caulk, and/or combinations of thereof, such as using a heating fan.

It is contemplated that the act 215 of tailoring the texture of the applied caulk may also be carried out after the caulk is dried in act 219. Tailoring the texture of the caulk after the caulk has dried may provide textures that cannot be achieved unless the caulk has dried. An embodiment may include breaking the dried caulk to provide a jagged texture, or scraping the dried caulk to achieve a smoothed or rounded texture on a previously formed feature. Additionally, the act 210 encompassing the act 211 of applying the caulk 120 to the surface 110, the act 215 of texturing the caulk 120 on the surface 110, and the act of drying 219 the textured caulk 120 may be repeated more than one time to achieve the desired textured effect or layering.

Referring again to FIG. 2, the act 220 of applying dye or color to the textured caulk may be carried out in various methods using any number of materials. The act 220 of applying dye to the textured caulk provides color to the textured surface, thereby enhancing the aesthetic characteristics of the artwork 100. Dyes suitable for use in embodiments include, but are not limited to, water-soluble dyes including both acidic and basic dyes, notably aniline-containing dyes; direct dyes; reactive dyes; azo dyes; any other suitable dyes, or combinations thereof. The act 220 of applying dye to the textured caulk may include using more than one dye 130. Using more than one dye 130 may include using more than one type of dye, using more than one consistency of dye, using more than one color of dye, using more than one layer of dye, and/or combinations thereof.

In an embodiment, a water-based or water-soluble aniline-containing dye is preferably used. Aniline-containing dyes are typically used to stain wood or dye clothing. However, aniline dyes exhibit ability to dye acrylic caulking. The color of aniline dye may be absorbed into the porous acrylic caulking more so than with a different caulking material such as a silicone-based caulk, or common paint texture mediums such as acrylic texture mediums including for example, but not limited to, those sold by Liquitex® Artist Materials. Aniline dyes typically come in premixed liquid form or powder form requiring mixing with a solvent to create a paintable or spreadable dye. Additionally, the premixed forms can be diluted with more solvent to decrease the intensity of the color of the dye. Typical solvents include but are not limited to water, alcohol, mineral spirits, or other organic solvents. Advantages of aniline-containing dyes, and most dyes in general, include the ability to control the intensity of the color of the dye through mixing or diluting the aniline-containing dye with more or less solvent. Shading or mixing colors of an aniline-containing dye may be accomplished by mixing multiple liquid aniline-containing dyes or by mixing multiple powdered aniline-containing dyes followed by dissolving the mixed aniline-containing dye powders with a solvent such as water.

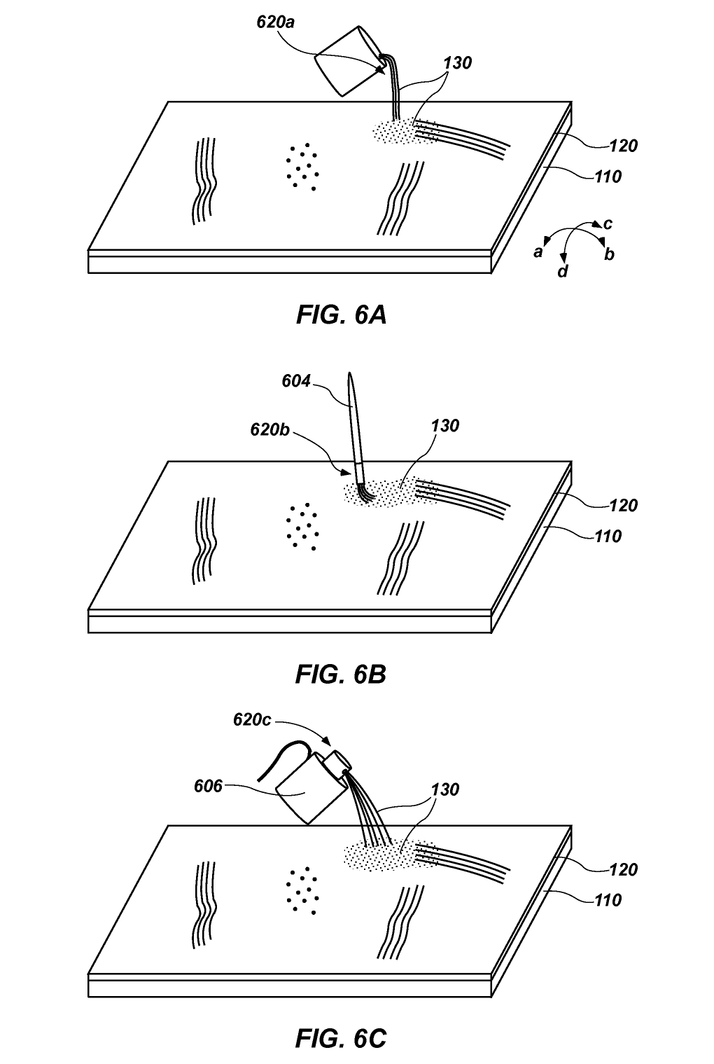

In an embodiment of the act 220 of applying dye to the textured surface, a user may mix an aniline-containing dye with water to arrive at the desired color and intensity of the dye, and then apply the dye to the textured surface using any one of a number of techniques. Techniques for applying a liquid dye to a textured surface are illustrated in FIGS. 6A-6C, include but are not limited to pouring, brushing, spattering, spraying, blotting, dabbing, rubbing, rolling, and combinations thereof onto a textured surface (caulk 620 applied to a substrate 610). In an embodiment illustrated in FIG. 6A, a liquid dye 630, for example, water-soluble aniline-containing dye, may be applied to an artwork 600a by the act 220a of pouring or otherwise applied in a large amount relative to the area of the textured surface covered by the water-soluble aniline-containing dye. A user may then tilt the textured surface along the axes a-b, c-d, and/or combinations thereof, to allow the aniline-containing dye to run over different portions of the textured surface. In embodiments a runny or streaked appearance may be achieved by applying dye in such a manner. In an embodiment, the intersection of different colored dyes 630 on a textured surface may be manipulated to provide a more or less faded or blended/mixed appearance.

In an embodiment, a liquid water-soluble aniline-containing dye may be applied to a textured surface by brushing the liquid water-soluble aniline dye onto the textured surface. As illustrated in an embodiment in FIG. 6B, the act 220 of applying a dye 630 to a textured surface of and artwork 600b, the act 220b of brushing may include different variations of brush strokes including but not limited to long brush strokes, short brush strokes, stabbing or patting brush strokes, and/or combinations thereof. Additionally, different appearances may be created by using different types of brushes 604 to apply the dye. Brushes 604 may include, for example, paint brushes having; longer bristles, shorter bristles, softer bristles, stiffer bristles, more bristles, less bristles, and/or combinations thereof. Brushes 604 may include brushes having different styles such as a round brush, a flat brush, a bright brush, a filbert brush, a fan brush, an angle brush, a mop brush, a stippler brush, a rigger brush, a sponge brush or other brushes known in the art. Brushes 604 may include bristles made from a number or materials such as animal fur (i.e. sable), synthetic (i.e. nylon), or any other material used to make paint brushes. It will be readily recognized that after one type of the act 220 of applying dye to the textured surface, a user may further tailor or customize the appearance of the dyes on the textured surface using any of the application techniques discussed above including, by way of example, brushing the dye.

In an embodiment the act 220 of applying dye to a textured surface illustrated in FIG. 6C, a sprayer 606 may be used to apply the dye 630 to the textured surface of artwork 600c by the act of spraying 220c the dye onto the textured surface. Embodiments of sprayers 606 may include, but are not limited to, aerosol spray cans, squeeze or pump spray bottles (i.e. similar to those commonly employed to apply household cleaning agents), pressurized paint spray guns, pump sprayers, and any other sprayer suitable to spray a liquid onto a surface. In embodiments, water-soluble aniline containing dyes may be mixed with each other by applying (by any of the methods describe herein) one or more water-soluble aniline-containing dyes on top of another water-soluble aniline-containing dye, which may be carried out on or off of the textured surface. Accordingly colors, intensity and/or thickness of the aniline containing dyes may be tailored to the desired appearance.

Referring again to FIG. 2, in an embodiment, the act 220 of applying dye to a textured surface includes combining or changing the color of dyes 130 in situ. In an embodiment, a textured surface may have multiple colored dyes 130 applied thereto using any of the techniques discussed above. Further, the undried liquid dyes may be separated by undyed portions or different color dyed portions of the textured surface. A user may then tilt the textured surface to allow the undried liquid dyes to run together, thereby mixing colors. A user may tilt the textured surface a specific amount and/or for a specific duration in order to achieve the desired mixing results. In an embodiment, a user may apply a red water-soluble aniline-containing dye to a textured surface by pouring and an aniline-containing water-soluble aniline dye by brushing, wherein, the user may tilt the textured surface to force the red water-soluble aniline-containing dye to run into the blue water-soluble aniline-containing dye, thereby creating a portion of the textured surface appearing purple.

In an embodiment, a user may apply more solvent to a liquid dye after it has been applied to the textured surface, thereby diluting or fading the color of the dye on the textured surface. A user may wish to change the color or intensity of a dye 130 once it has dried on the textured surface. Accordingly, a user may apply multiple coats or layers of dye, including different colors, after applying a first coat of dye or dyes 130 to the textured surface.

In another embodiment of the act 220 of applying dye to a textured surface, a user may apply dry dye powder to the textured surface. Further, the user may then apply solvent directly to the textured surface including the dry dye powder to dissolve the dye powder into the solvent. The dissolved dye powder, now in a liquid form, may then be spread or manipulated on the textured surface in any of the manners described above for applying a liquid dye to a textured surface. In an embodiment, a dry water-soluble aniline dye powder may be applied to a textured surface and then brushed or otherwise wetted with water to dissolve and spread the liquid aniline-containing dye, thereby allowing the water-soluble aniline-containing dye to adsorb and/or absorb into the textured surface. In an optional act, a user may allow applied dye or dyes to dry before moving on to the next act of the method 200 of creating an artwork. Drying the applied dye 130 may be accomplished by leaving the textured dyed surface 120 in an ambient environment for an amount of time sufficient to accomplish drying. In another embodiment, drying the applied dye may include heating the textured dyed surface or forcing air over the textured dyed surface, and/or combinations of thereof, such as using a heating fan. In an embodiment, alcohol-soluble aniline-containing dyes may be used to achieve faster drying times. Drying the applied dye or dyes before further acts are carried out ensures that the dyes remain in place during further acts.

It will be readily understood that embodiments of the invention described using water-soluble aniline dyes may also be created using a number of differing dyes, and that the water-soluble aniline dyes discussed are merely illustrative of one of many dyes contemplated.

Referring still to FIG. 2, the act 230 of coating the dyed surface with a protectant 140 follows the act 220 of applying a dye to the textured surface. A protectant or protectants 140 may be used to substantially seal and stabilize dyes applied to the textured surface of the artwork 100. Suitable protectants 140 include, but are not limited to, varnishes including urethanes or polyurethanes including oil-based, oil-based polyurethane spar varnish, water-based, water-based oil-modified embodiments, lacquer, acrylic varnish, spar varnish, resin varnishes including shellac, or any other varnish capable of protecting a dyed surface; acrylic sealants; any other coating capable of sealing and protecting an underlying item, or combinations thereof. The term “varnish” is commonly used as a generic term for a coating or finish. Protectants 140, as used herein, are typically used in the woodworking industry and, more particularly, in the wood flooring industry. The protectant 140 may include its own color, as typically done in the wood flooring industry, or in other embodiments the protectant may be clear. If it is desired that no additional color be added to the artwork 100 after dye 130 is applied in act 220, then clear protectant 140 may be employed. Without a protectant an artwork may require protective glass to provide protection of the features therein. Glass may produce glare thereby limiting the visual effect of the artwork, and non-glare glass tends to decrease the visual brilliance or vibrancy of artworks. A protectant 140 may eliminate the need for protective glass over an artwork.

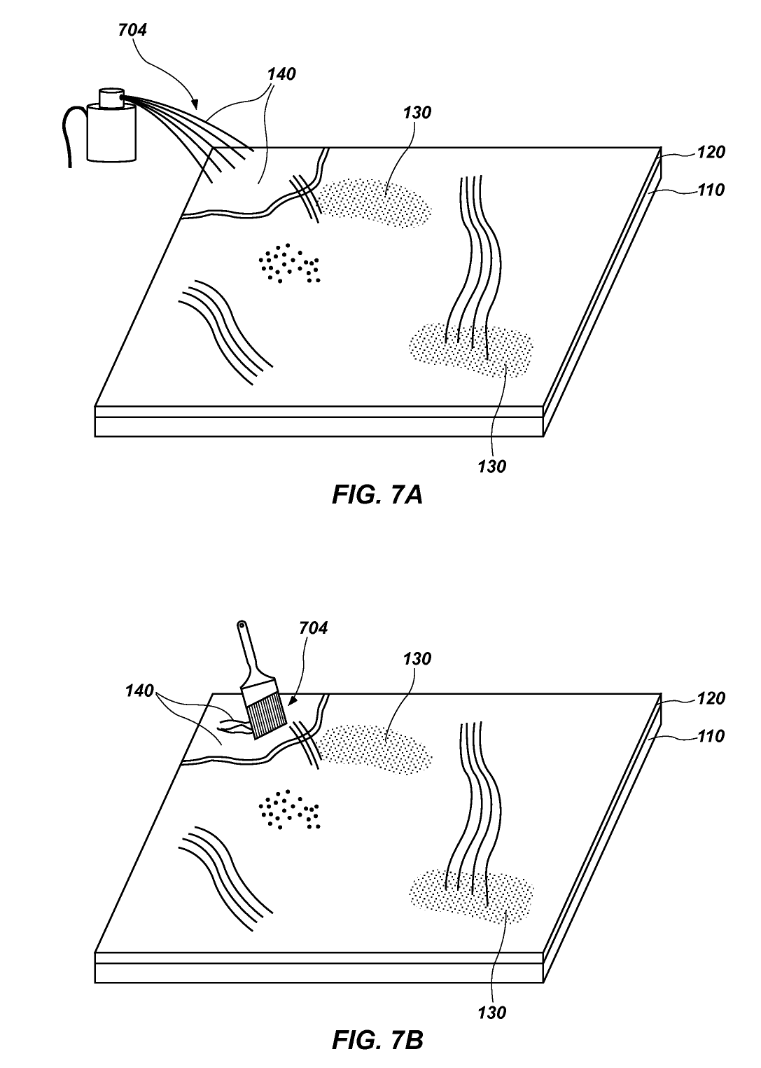

In an embodiment, as illustrated in FIG. 7A a protectant 740 may be applied by the act 230a of spraying the protectant 740 onto the dyed textured surface of the artwork 700a using a sprayer 706. The caulking 720 on the surface 710 and the dye 730 are all sealed and stabilized by the protectant 730. Further, the combination of certain protectants, such as oil-based polyurethane varnishes and water-soluble aniline dyes provides the added benefit of enhancing the vibrancy of the color in the dyes. Applying a protectant by spraying limits the pressure applied to the water-soluble aniline dyes, thereby limiting the potential for any movement of the dyes upon application of the protectant. Spraying a protectant 740 may be accomplished by using any of the methods and apparatuses discussed above for spraying a dye 130 or 630. In an embodiment, the protectant 740 may be applied to the textured dyed surface by rubbing the protectant onto the textured dyed surface from a protectant soaked article such as a portion of a rag. In another embodiment, as illustrated in FIG. 7B, the protectant 740 may be applied to a textured dyed surface of an artwork 700b by the act 230b of brushing the protectant 740 onto the textured dyed surface using a brush 704, such that the caulking 720 on the surface 710 and the dye 730 are all sealed and stabilized by the protectant 730.

In an embodiment, the protectant may be an oil-based clear polyurethane varnish. Oil-based polyurethane varnishes are normally used to protect wood, although many consider oil-based polyurethane unsuitable for protecting detailed work. Oil-based polyurethane varnishes may include a tint or color added, while others are clear. Many oil-based polyurethane varnishes also have a tendency to develop a yellow tint over time. In an embodiment, the protectant may be a water-based polyurethane varnish. Water-based polyurethane varnish has a tendency to provide a clearer (i.e. colorless) finish than oil-based polyurethane varnish, however, water-based polyurethane varnish may add a cloudiness to the appearance of the finished product and does not set up as hard as an oil-based polyurethane. Water-based oil-modified polyurethanes offer a combination of the advantages offered by water-based and oil-based polyurethanes individually, including but not limited to fast drying time and a durable finish.

In an embodiment, the protectant 140 may be an oil-based clear polyurethane-containing varnish, applied over water-soluble aniline dyes 130 applied to a textured surface. In such an embodiment, the oil-based clear polyurethane-containing varnish seals and stabilizes the underlying water-soluble aniline dyes, thereby protecting the dyes from further alteration by water or other factors. The combination of water-soluble aniline dyes and oil-based polyurethane-containing protectant also results in an unexpected vibrancy in the appearance of the color of the dyes not found with non-oil-based polyurethane protectants. Further, using an oil-based polyurethane-containing protectant in combination with water-soluble dyes results in far less reaction or interaction between the dyes and the protectant. For example, a water-based aniline dye may be altered after application by subsequent application of a water-based polyurethane protectant by way of reaction of the water in the polyurethane with the water-soluble dyes on the textured surface. Further, using an oil-based polyurethane-containing protectant 140 in combination with water-soluble aniline dyes 130 results in less dye float, or dye being picked up off of the textured surface by the solvent in the polyurethane and floating or becoming part of the protectant coating. In an embodiment, the oil-based polyurethane-containing protectant 140 may include a light protecting component that may prevent or inhibit damage from artificial or natural light including but not limited to ultraviolet (“UV”) light damage from the sun or light bulbs. The light protecting component may be incorporated in the oil-based polyurethane-containing protectant or may be mixed into the oil-based polyurethane-containing protectant before application to an artwork as described herein. Suitable oil-based polyurethane-containing protectants having a light protecting component therein include but are not limited to Minwax® Helmsman® Spar Polyurethane, or Cabot Spar Varnish. In an embodiment, the substantially silicone-free acrylic latex caulk 120 is applied a canvas. The substantially silicone-free acrylic latex caulk 120 is then manipulated with a spatula and brush to tailor the texture of the surface to provide a thick painted appearance and texture (i.e. appearance that the surface has been painted with a thick paint and the paint has dried leaving the brush strokes evident of the canvas). After the substantially silicone-free acrylic latex caulk 120 dries, leaving a textured surface, at least a single water-soluble aniline-containing dye 130 is selected and applied to the textured surface. In an embodiment, the water-soluble aniline-containing dye is applied to the surface by brushing at least a single water-soluble aniline-containing dye 130 onto the textured surface and pouring at least a single water-soluble aniline-containing dye 130 on the textured surface followed by subsequent brushing to spread and mix the dyes as desired. Optionally, the dyes 130 can be diluted or made less intense, in situ, by adding water to the water-soluble aniline-containing dyes 130. The dyes 130 adhere to the substantially silicone-free acrylic latex caulk 120 resulting in vibrant colors because the high saturation of the water-soluble aniline dye into the substantially silicone-free acrylic latex caulk. Further, after the at least a single water-soluble aniline-containing dye 130 dries, an oil-based polyurethane-containing protectant 140 may be applied over the caulking 120, dye 130, and canvas collectively to provide sealing (i.e., protection), protection from light damage, color enhancement and stabilization. The oil-based polyurethane-containing protectant 140 may be sprayed from an aerosol can onto the caulking, dye and canvas collectively. Traditionally, aniline-containing dyes are used to dye wood or textiles not caulking Traditionally, polyurethane-containing protectants are used to protect and seal wood, not aniline dyes or caulking. However, the resulting artwork 100 made according to the above embodiment, exhibits a vibrancy and brilliance of color and texture not believed by the inventors to have seen or otherwise possible using other materials and techniques. For instance, the oil-based polyurethane provides additional vibrancy or intensity to the dyes not present without the use of oil-based polyurethane. Additionally, as mentioned above, the high saturation and distinctive vibrant appearance of the water-soluble aniline-containing dyes are not possible without the use of a substantially silicone-free acrylic latex caulk. The unlikely combination of a silicone-free acrylic latex caulk 120, water-soluble aniline-containing dyes 130 and oil-based polyurethane protective coating 140 renders unique, highly saturated, vibrant colors to an artwork made using the methods disclosed.

### Working Example

In an embodiment, a substantially silicon-free acrylic latex painter's caulk was squeezed out of a tube and applied onto a gesso canvas. The silicone-free acrylic latex caulk was then manipulated with a spatula and/or brush to tailor the texture of the surface to provide a thick painted appearance and texture. The resulting textured surface was then dried in ambient air. Next, multiple colors of water-soluble aniline dye were sprayed onto the textured surface. The colors of water-soluble aniline-containing dye were sprayed and mixed with each other until the desired color saturation and appearance was reached. The water-soluble aniline dyes were dried in ambient air. Next, an oil-based polyurethane-containing protectant having a light protecting component was sprayed onto the dried aniline dye and substantially silicone-free acrylic latex caulk. After drying, the oil-based polyurethane-containing protectant having a light protecting component provided an intensity and vibrancy to the appearance of the water-soluble aniline-containing dyes that was not present before application of the oil-based polyurethane-containing protectant. Further, the oil-based polyurethane-containing protectant having a light protecting component gave the water-soluble aniline-containing dyes and overall artwork a wet or freshly painted appearance.

While various aspects and embodiments have been disclosed herein, other aspects and embodiments are contemplated. The various aspects and embodiments disclosed herein are for purposes of illustration and are not intended to be limiting.

1. A method of making an artwork, the method comprising:
texturing a surface of a canvas including,
applying a substantially silicone-free caulk to the canvas;
tailoring the texture of the applied substantially silicone-free caulk to create a roughened surface; and
applying one or more solutions consisting essentially of one or more water-soluble aniline-containing dyes to the roughened surface; and
coating the roughened surface including the one or more solutions consisting essentially of one or more water-soluble aniline-containing dyes with a polyurethane-containing protectant.

2. The method of claim 1 wherein applying a substantially silicone-free caulk includes squeezing the substantially silicone-free caulk onto the canvas from a squeeze bottle.

3. The method of claim 1 wherein applying a substantially silicone-free caulk includes:
thinning the substantially silicone-free caulk by mixing the substantially silicone-free caulk with at least one of water or a solvent; and
at least one of spraying, brushing, pouring, or rolling the thinned silicon-free caulk onto the canvas.

4. The method of claim 1 wherein tailoring the texture of the silicon-free caulk includes using at least one of a spatula, a brush, a sponge, or a hand.

5. The method of claim 1 wherein applying one or more solutions consisting essentially of one or more water-soluble aniline-containing dyes includes at least one of spraying, brushing, rolling, dabbing, blotting, or spattering the one or more water-soluble aniline-containing dyes onto the roughened surface.

6. The method of claim 1 wherein applying one or more solutions consisting essentially of one or more water-soluble aniline-containing dyes includes pouring the one or more solutions consisting essentially of one or more water-soluble aniline-containing dyes onto a textured surface and tilting the surface to allow the one or more solutions consisting essentially of one or more water-soluble aniline-containing dyes to run on the textured surface.

7. The method of claim 6, wherein pouring one or more solutions consisting essentially of one or more water-soluble aniline-containing dyes onto a textured surface and tilting the textured surface to allow the one or more solutions consisting essentially of one or more water-soluble aniline-containing dyes to run on the textured surface includes allowing one or more one solutions consisting essentially of one or more water-soluble aniline-containing dyes to run into another solution consisting essentially of one or more water-soluble aniline-containing dye on the textured surface, thereby mixing the solutions consisting essentially of one or more water-soluble aniline-containing dyes on the textured surface.

8. The method of claim 5 wherein coating the roughened surface containing the one or more solutions consisting essentially of one or more water-soluble aniline-containing dyes with a polyurethane-containing protectant includes at least one of spraying, brushing, or rubbing the polyurethane-containing protectant onto the textured surface containing the one or more solutions consisting essentially of one or more water-soluble aniline-containing dyes.

9. The method of claim 6 wherein coating the roughened surface containing the one or more solutions consisting essentially of one or more water-soluble aniline dyes with a polyurethane-containing protectant includes at least one of spraying, brushing, or rubbing, of the polyurethane-containing protectant onto the roughened surface containing the one or more solutions consisting essentially of one or more water-soluble aniline-containing dyes.

10. The method of claim 1, further comprising drying the applied and roughened substantially silicone-free caulk before the act of applying one or more solutions consisting essentially of one or more water-soluble aniline-containing dyes to the roughened surface.

11. The method of claim 1 wherein the polyurethane-containing protectant includes an oil-based polyurethane-containing protectant.

12. The method of claim 1, further comprising drying the one or more applied solutions consisting essentially of one or more water-soluble aniline-containing dyes before coating the textured surface including the one or more solutions consisting essentially of one or more water-soluble aniline-containing dyes with a polyurethane-containing protectant.

13. The method of claim 1 wherein the substantially silicone-free caulk includes a substantially silicone-free acrylic latex caulk.

14. A method of making an artwork, the method comprising:
texturing a surface of a canvas including,
applying a substantially silicone-free caulk to the canvas;
tailoring the texture of the applied substantially silicone-free caulk to create a roughened surface using at least one of a spatula, a brush, a sponge, or a hand;
drying the applied and roughened substantially silicone-free caulk; and
applying one or more solutions consisting essentially of water and one or more water-soluble aniline-containing dyes to the roughened surface; and
coating the roughened surface including the one or more solutions consisting essentially of water and one or more water-soluble aniline-containing dyes with an oil-based polyurethane-containing protectant having a light protecting component therein.

15. The method of claim 14 wherein applying one or more solutions consisting essentially of water and one or more water-soluble aniline-containing dyes includes at least one of spraying, brushing, rolling, dabbing, blotting, pouring, or spattering the solutions consisting essentially of water and one or more water-soluble aniline-containing dyes onto the roughened surface.

16. The method of claim 15 wherein applying the one or more solutions consisting essentially of water and one or more water-soluble aniline-containing dyes includes tilting the roughened surface to allow the one or more solutions consisting essentially of water and one or more water-soluble aniline-containing dyes to run on the roughened surface.

17. The method of claim 16 wherein tilting includes allowing the one or more one solution consisting essentially of water and one or more water-soluble aniline-containing dyes to run into another solution consisting essentially of water and one or more water-soluble aniline-containing dye on the roughened surface, thereby mixing the solutions consisting essentially of water and one or more water-soluble aniline-containing dyes on the roughened surface.

18. The method of claim 16 wherein tilting the roughened surface to allow the one or more solutions consisting essentially of water and one or more water-soluble aniline-containing dyes to run on the roughened surface includes adding more water to the one or more of the solutions consisting essentially of water and one or more water-soluble aniline-containing dyes on the roughened surface in situ.

19. The method of claim 16, wherein coating the roughened surface containing the one or more solutions consisting essentially of water and one or more water-soluble aniline-containing dyes with an oil-based polyurethane-containing protectant includes at least one of spraying, brushing, or rubbing, the oil-based polyurethane-containing protectant onto the roughened surface containing the one or more solutions consisting essentially of one or more water-soluble aniline-containing dyes.

20. The method of claim 16 wherein tailoring the texture of the applied substantially silicone-free caulk to create a roughened surface includes forming at least a single three-dimensional feature with the applied substantially silicone-free caulk.

21. The method of claim 14 wherein the substantially silicone-free caulk includes substantially silicone-free acrylic latex caulk.

22. The method of claim 14, further comprising drying the one or more solutions consisting essentially of water and one or more water-soluble aniline-containing dyes on the roughened surface before coating the roughened surface including the one or more solutions consisting essentially of water and one or more water-soluble aniline-containing dyes with an oil-based polyurethane-containing protectant.

23. The method of claim 14, wherein applying one or more solutions consisting essentially of water and one or more water-soluble aniline-containing dyes to the roughened surface includes mixing the colors of more than one solution consisting essentially of water and one or more water-soluble aniline containing dye before spraying more than one solution consisting essentially of water and one or more water-soluble aniline-containing dye on top of another solution consisting essentially of water and one or more water-soluble aniline-containing dye on the roughened surface.

24. A method of making an artwork, the method comprising:
texturing a surface of a canvas including,
applying a substantially silicone-free acrylic latex caulk to the canvas using at least one of squeezing from a squeeze tube, pouring, spraying, or brushing;
tailoring the texture of the applied substantially silicone-free acrylic latex caulk to create a roughened surface using at least one of a spatula, a brush, or a hand;
drying the applied and roughened substantially silicone-free acrylic latex caulk;
solvating an aniline-containing dye powder in a solvent to form a dye solution;
applying the dye solution to the roughened surface by at least one of spraying, brushing, rolling, dabbing, blotting, pouring, or spattering, the dye solution onto the roughened surface; and
after the act of applying the dye solution, coating the roughened surface with an oil-based polyurethane-containing protectant by at least one of spraying, brushing, or rubbing the oil-based polyurethane-containing protectant onto the roughened surface.

25. The method of claim 24, further comprising drying the dye solution on the roughened surface.

26. The method of claim 25, further comprising a second act of applying one or more solutions consisting essentially of solvent and one or more water-soluble aniline-containing dyes to the roughened surface follows drying the dye solution on the roughened surface.

27. The method of claim 24, further comprising a second act of tailoring the texture of the applied substantially silicone-free caulk to create a roughened surface follows drying the applied and roughened substantially silicone-free acrylic latex caulk.

28. The method of claim 24 wherein applying the dye solution to the roughened surface includes adding more water to the dye solution on the roughened surface.

29. An artwork, comprising:
a substrate; and
a substantially silicone-free caulk covering at least a portion of the substrate to define a textured surface;
at least a single water-soluble aniline-containing dye applied to the textured surface; and
an oil-based polyurethane-containing protectant coating the textured surface and the at least a single water-soluble aniline-containing dye.

30. The artwork of claim 29 wherein the substrate includes a canvas.

31. The artwork of claim 30 wherein the substrate includes a canvas substantially entirely covered by a substantially silicone-free acrylic latex caulk.

32. The method of claim 1, further comprising solvating an aniline-containing dye powder in a solvent to form the one or more solutions consisting essentially of one or more water-soluble aniline-containing dyes.
